(19) United States
(12) Patent Application Publication
(10) Pub. No.: US 2015/0096218 A1
(43) Pub. Date: Apr. 9, 2015

(54) Wick Dispenser for Dispensing Animal Scent and Method of Using Same

(71) Applicant: Eric J. Burr, Bennington, NE (US)

(72) Inventor: Eric J. Burr, Bennington, NE (US)

(21) Appl. No.: 14/500,221

(22) Filed: Sep. 29, 2014

Related U.S. Application Data
(60) Provisional application No. 61/887,568, filed on Oct. 7, 2013.

(51) Int. Cl. A01M 31/00

(52) U.S. Cl. CPC A01M 31/008
USPC 43/1

(57) ABSTRACT

A method and apparatus for dispensing a scent for attracting big game animals, includes a container with a wick that is configured to be easily inserted into the container in the field. The scent within the container is thickened so it will not drip too fast and preferably contains a substance to prevent freezing. The preferred scent is urine from the female species, during estrus, of the big game being hunted.

### CROSS REFERENCE TO RELATED APPLICATIONS

This application claims the benefit of U.S. Provisional Patent Application Ser. No. 61/887,568 filed Oct. 7, 2013 entitled “Wick Dispenser for Dispensing animal Scent and Method of Using Same” which is incorporated by reference herein in its entirety.

### TECHNICAL FIELD

This invention relates generally to hunting big game and more particularly to an apparatus and method of dispensing animal scent in the woods while hunting big game.

### BACKGROUND

It is well known that deer, and many other big game animals, have a highly developed sense of smell. It is well known that they can smell things that humans cannot.

Whitetail bucks, in particular, are known to be attracted to the smell of whitetail deer urine, whether it is from another buck or from a doe. This attraction is much greater during the mating season, commonly referred to as “the rut”, when bucks are looking for a doe in estrus, commonly referred to in the deer hunting community as “a doe in heat”. So during the mating season, while a buck might be curious about and consequently attracted to any deer urine it smells, the buck will be infinitely more interested in doe urine from a doe in estrus during the mating season.

Consequently, there are countless brands of doe in estrus products on the market which can be purchased on the internet, in sporting goods stores or in sporting goods departments of other general merchandise stores for example. Also, there is a plethora of various types of ways to dispense the urine in the woods, from simply just pouring or spraying the doe in estrus urine from a container onto, the ground, a bush, tree or plant to more elaborate ways of pouring or spraying the doe urine into the air or on an absorbent material that is then attached to something in the woods where deer are to be hunted.

U.S. Pat. No. 4,667,430 to Zeise issued in 1987 shows one such deer urine dispenser using a capillary feed tube for dispensing deer urine from a container onto the ground. While this works well, the capillary feed tube is somewhat complicated and expensive way to produce a desired dispensing speed.

Accordingly, there is a need for a cheaper and simpler solution to this aforementioned dispensing problem.

### BRIEF DESCRIPTION OF THE DRAWINGS

The above needs are at least partially met through provision of the method and apparatus described in the following detailed description, particularly when studied in conjunction with the drawings, wherein:

FIG. 1 is a side elevational view of a wick scent dispenser constructed in accordance with the present invention being used in the woods to attract a deer;

FIG. 2 is a perspective view of the present invention shown prior to assembly for use in the field;

FIG. 3 is an enlarged partial side elevational view with a portion broken away to show one way the a cap can be attached to a container holding urine from a big game animal and showing the wick in solid lines as it is prepared to be inserted into the container and in dashed lines to show where it will be after insertion into the container;

FIG. 4 is a side elevational view like FIG. 3, but having a portion thereof broken away to show the wick extending to the inside of the container;

FIG. 5 is a view looking up from below FIG. 4 with the cap open before the wick is inserted to the FIGS. 3 and 4 position; and

FIG. 6 is a cross sectional view of the cap portion taken along line 6-6 of FIG. 5.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

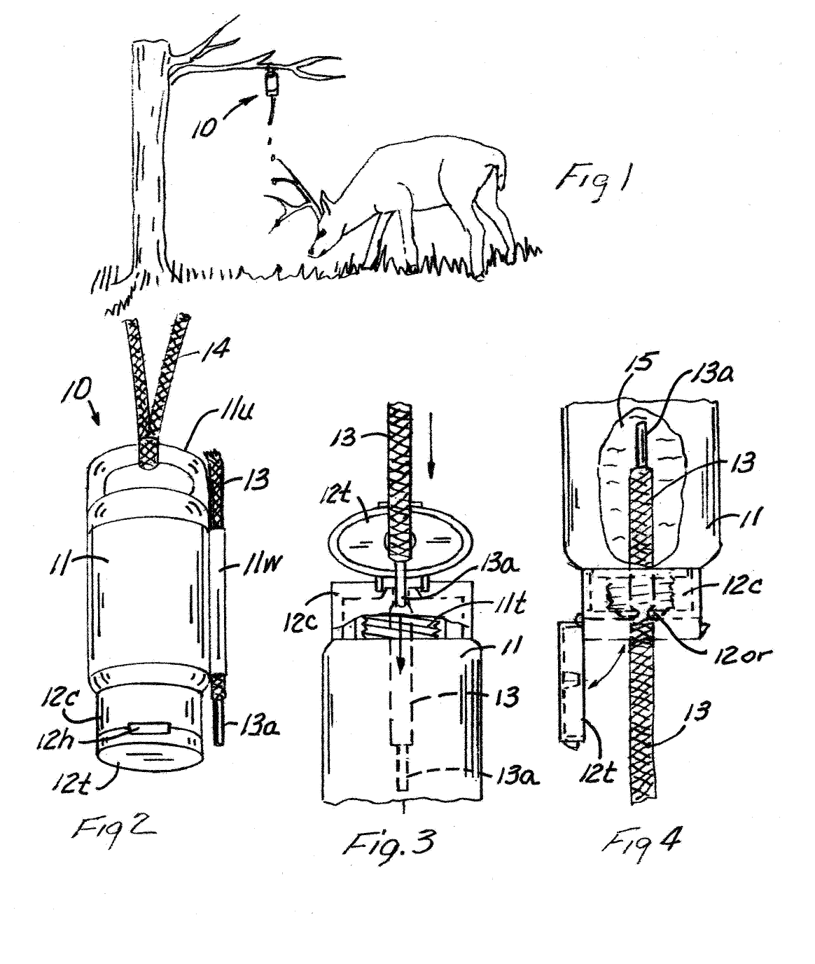

Referring now to the drawings, wherein like reference numerals indicate identical or similar parts throughout the several views, FIGS. 1-6 show an apparatus and method of dispensing animal scent in the woods while hunting big game.

Looking to FIG. 1, a dispensing apparatus 10 is shown hanging from a limb of a tree while dispensing animal scent in the woods by dripping while hunting big game.

Looking to FIG. 2, the dispensing apparatus 10 has a container 11 for holding a scent used for hunting big game, such as urine from the species of animal being hunted, and most preferably urine from the female of the species while such female is in estrus.

The container 11 has a U-shaped handle 11u on one end of the container 11 for being able to use a cord, such as part of a shoe string 14, to tie the apparatus 10 to a limb or branch of a tree or bush, or perhaps to other things, such as a fence.

Initially the container 11 is packaged with a wrapper/label 11w which sticks to at least the front and back side of the container 11, but which is also wrapped around a wick 13, which in a preferred embodiment is a boot lace having a plastic end 13a thereon for reasons which will be explained below.

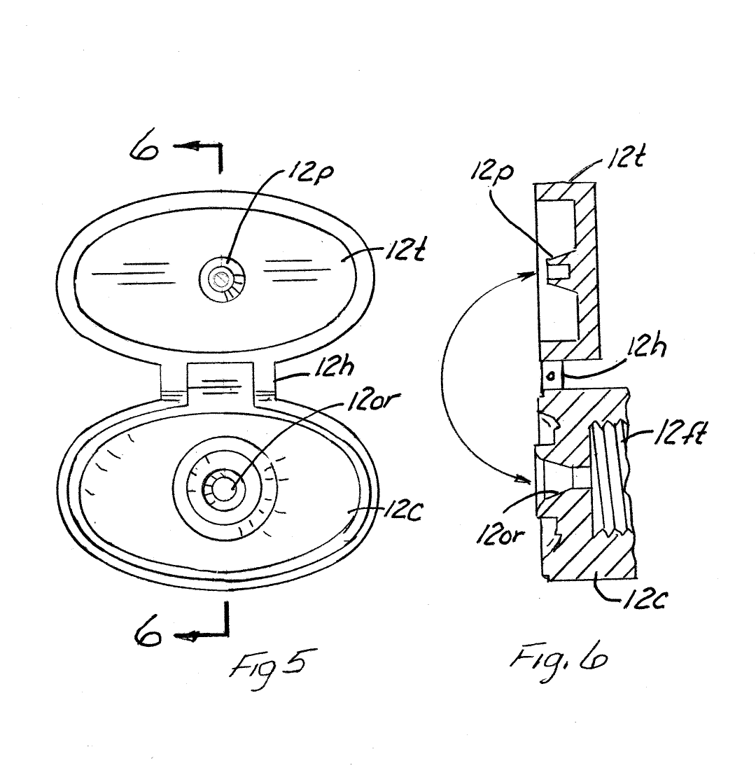

The container 11, shown in detail in FIGS. 2-6, has a cap 12c, which is actually shown inverted in FIGS. 1-4, but is the top of the container 11 when liquid scent 15 (FIG. 4) is poured into it, for example when the cap 12c is removed from the threaded part 11t of the container 11 by unscrewing the cap 12c at fastener threads 12ft (FIG. 6) from the threaded portion 11t of the container 11 shown in FIG. 3. Of course, the cap 12c can be sealingly attached to the container 11 in other ways known to those in the art. Looking to FIGS. 5 and 6, the top 12t is pivotally attached to the cap 12c by a hinge 12h. When the cap is closed, as shown in FIG. 2, a plug portion 12p on top 12t extends into the orifice 12 or to block the flow of the liquid out of the container 11.

So after the scent 15 (FIG. 4) is placed in the container 11 and the cap 12c with the top lid 12t in the position shown in FIG. 2 is on it, the dispensing apparatus would be sold to a hunter. Directions (not shown) on the label 11w would typically be: “Remove cap and feed two inches (2″) of the wick through the hole in the cap. Replace cap. Hang from a branch.”

Accordingly, when the hunter takes the dispenser 10 into the woods and finds a place to which he or she wants to lure a big game animal, he/she would follow the instructions given above and begin to thread the wick 13 into the orifice 12or best shown in FIG. 3 by first placing the smaller end 13a of the wick first through the orifice 12or (see orifice 12or better in FIGS. 5 and 6).

After the wick is threaded by approximately the amount shown in FIG. 4, the scent dispensing apparatus 10 is hung from a branch as shown in FIGS. 1 and 4 so that the liquid scent 15 drips slowly onto the ground or onto whatever is under the wick 13 so as to attract the attention of a sensitive nose of the big game being hunted as depicted in FIG. 1.

During the breeding season (rut), big game animals, especially the male of the species, are often attracted to urine smells of the female and this is pronounced when for example a doe deer is in estrus. So “doe in heat” or “doe in estrus’ urine can be used interchangeably.

If animal urine is the liquid 15 in container 11, it would drip out too quickly, unless it was so cold that it became frozen first. So it is necessary to modify the animal urine in order for the drip dispenser 10 to work slowly enough to be used most efficiently.

So ideally urine from a big game animal, such as a whitetail doe when the doe is in estrus, is the main ingredient of the liquid 15. Mixed with the doe urine is sodium benzoate, which is an antimicrobial agent. Glycerin is added to raise the freezing point. Glycerin is also a preservative. In the preferred embodiment, ten percent (10%) by volume of the liquid 15 is glycerin. Corn starch and maltodextrin are also added as thickening agents to make the liquid 15 drip through the wick 13 slower. A commercially available product, THICK IT™, which is comprised of corn starch and maltodextrin can be used by adding it as 5 to 15 percent of the weight of the liquid 15. While the specific “recipe” or formula for this liquid 15 is disclosed above, it is to be understood that other mixtures of these and or other ingredients are also contemplated to be within the scope of this invention. One option is to add cedar oil, or other wood oils, with the pre-rut formula to simulate a buck scraping a tree.

The preferred formula is 1800 milliliters (mL) of doe estrus, 80 grams of THICK IT®™ brand thickener and 200 milliliters (mL) of glycerol.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. An apparatus for dispensing liquid attractant comprising:
a container having walls for holding a liquid;
the liquid containing ingredients for attracting animals thereto;
an opening disposed in the container;
a wick disposed through the opening in the container and extending from inside the container to the outside of the container; and
the liquid being in contact with the wick inside of the container, the liquid further having a viscosity higher than that of water to cause the liquid in the container to move more slowly through the wick when the container is disposed above that part of the wick extending from the container, than if the viscosity of the wick was the same as, or close to, the viscosity of water.

2. The apparatus of claim 1 wherein the liquid is animal urine.

3. The apparatus of claim 2 wherein the liquid is deer urine.

4. The apparatus of claim 3 wherein the deer urine is from a doe in estrus.

5. The apparatus of claim 4 wherein the deer urine contains glycerin for raising the temperature at which the liquid will freeze.

6. The apparatus of claim 5 wherein ten percent (10%) by volume of the liquid is glycerin.

7. The apparatus of claim 4 wherein the deer urine contains an antimicrobial agent.

8. The apparatus of claim 7 wherein the antimicrobial agent is sodium benzoate.

9. The apparatus of claim 1 wherein the viscosity of the liquid has been raised due to the presence of corn starch.

10. The apparatus of claim 1 wherein the viscosity of the liquid has been raised due to the presence of maltodextrin.

11. The apparatus of claim 1 wherein the viscosity of the liquid has been raised due to the presence of corn starch.

12. The apparatus of claim 1 wherein the viscosity of the liquid has been raised due to the presence of corn starch and maltodextrin.

13. The apparatus of claim 1 wherein the liquid is animal urine and a commercially available product, THICK IT™, comprised of corn starch and maltodextrin, has been added in a 5 to 15 percent of an original weight of the urine.

14. The apparatus of claim 1 wherein a formula for the liquid is approximately in a respective percentage corresponding to the respective percentage of a mixture formed using 1800 milliliters (mL) of doe estrus, 80 grams of THICK IT®™ brand thickener and 200 milliliters (mL) of glycerol.

15. An apparatus for dispensing liquid attractant comprising:
a container having walls for holding a liquid;
an opening disposed in the container;
a cap for selectively sealingly closing the opening in the container; and
a wick disposed completely on the outside of the container and removeably attached to the outside of the container, the wick having a diameter with at least one end thereof which is smaller in diameter than the diameter of the rest of the wick for facilitating easy installation of the wick into and through the opening in the container when desired.

16. The method of claim 15 comprising putting a liquid into the container that is an attractant for animals.

17. The method of claim 16 wherein a formula for the liquid is approximately in a respective percentage corresponding to the respective percentage of a mixture formed using 1800 milliliters (mL) of doe estrus, 80 grams of THICK IT®™ brand thickener and 200 milliliters (mL) of glycerol.

18. A method of using the apparatus of claim 15 comprising:
removing the wick from the outside of the container;
moving the cap from the opening in the container; and
inserting the one end that is smaller of the wick into the opening and forcing some of the rest of the wick into the inside of the container into contact with the liquid inside of the container and leaving some of the wick outside of the container.

19. The method of claim 18 comprising:
attaching the container to an object in an orientation so that the wick is under the container for allowing the liquid to saturate the wick and cause a slow transfer of the liquid from the inside to the outside of the container.

20. The method of claim 18 wherein the liquid is animal urine and the object is a tree located in a place where deer can be hunted.
